(19) United States
(12) Patent Application Publication
(10) Pub. No.: US 2024/0123958 A1
(43) Pub. Date: Apr. 18, 2024

(54) MASTER PISTON FOR A HYDRAULIC VEHICLE BRAKE

(71) Applicant: Trelleborg Sealing Solutions Germany GmbH, Stuttgart (DE)

(72) Inventors: Jan Kolodziej, Fellbach (DE); Julian Feucht, Metzingen (DE); Ralf Gergen, Pfullingen (DE)

(73) Assignee: Trelleborg Sealing Solutions Germany GmbH, Stuttgart (DE)

(21) Appl. No.: 18/545,157

(22) Filed: Dec. 19, 2023

Related U.S. Application Data
(63) Continuation of application No. PCT/EP2022/072124, filed on Aug. 5, 2022.

(30) Foreign Application Priority Data
Aug. 5, 2021 (DE) 10 2021 208 531.8

(51) Int. Cl. B60T 11/236; B60T 11/16; F15B 15/14

(52) U.S. Cl. CPC B60T 11/236; B60T 11/165; F15B 15/1452; B62L 3/023

(57) ABSTRACT

A master piston for a hydraulic vehicle brake is arranged in a master cylinder of the hydraulic vehicle brake and is movable in a reciprocal manner along a master piston longitudinal axis. The master piston has at least one piston element and a seal which is injection molded onto the piston element. The master piston has at least one guide portion for guiding the master piston in the master cylinder. The guide portion is elastically deformable at least in some portions in a radial direction to the master piston longitudinal axis. The guide portion is formed at least partially from a different material from the piston element. The piston element, the seal and the guide portion are produced together by a multi-component injection molding method. A method for producing the master piston is disclosed.

### CROSS-REFERENCE TO RELATED APPLICATIONS

This continuation application claims priority to PCT/EP2022/072124 filed on Aug. 5, 2022 which has published as WO 2023/012344 A1 and also the German application number 10 2021 208 531.8 filed on Aug. 5, 2021, the entire contents of which are fully incorporated herein with these references.

### DESCRIPTION

### Field of the Invention

The invention relates to a master piston for a hydraulic vehicle brake, a hydraulic vehicle brake and a method for producing the master piston.

### Background of the Invention

Hydraulic vehicle brakes for vehicles with handlebars, such as for example bicycles or motorcycles, which have a master piston and a master cylinder are known from the prior art. The master cylinder has a piston bore in which the master piston is arranged so as to be movable in a reciprocal manner along its longitudinal axis or axis of movement. The master cylinder also has an expansion tank which is connected via at least one opening to the piston bore for the exchange of fluid. The master piston has a piston element and the master piston has a seal which is arranged over the circumference of the piston element and which bears against the master cylinder in a dynamically sealing manner in order to create brake pressure in the master cylinder by displacing the master piston in the axial direction. In a state in which braking is not taking place, the master piston is arranged in the piston bore such that a defined pressure chamber is connected via the opening to the expansion tank. During a braking procedure, the master piston can be displaced axially in the direction of its longitudinal axis in the piston bore such that the seal slides over the opening, so that the pressure chamber in which the brake pressure prevails is not connected via the opening to the expansion tank. If the brake pressure is released, the master piston slides in turn with the seal over the opening so that the pressure chamber is connected to the expansion tank. Additionally, the master piston has a secondary seal which is arranged over the circumference of the piston element. During the braking procedure, the opening is arranged between the seal and the secondary seal.

Such a hydraulic vehicle brake is known, for example, from JP 2014-227079 A.

### SUMMARY OF THE INVENTION

It is the object of the invention to provide a master piston for a hydraulic vehicle brake which is configured in simple manner in terms of device technology and can be produced cost-effectively, and by which the pressure chamber can be reliably sealed. A further object of the invention is to provide a vehicle brake with the master piston which is configured in a simple manner in terms of device technology and is cost-effective.

The master piston according to the invention has the features specified in the claims. The object relative to the vehicle brake is achieved by a vehicle brake according to the features of the claims.

According to the invention, a master piston is provided for a hydraulic vehicle brake, in particular, a bicycle brake, which can be arranged in a piston bore of a master cylinder so as to be movable in a reciprocal manner along its longitudinal axis. Moreover, the master piston has at least one seal which is preferably arranged over the circumference of the master piston. In other words, a seal is provided on the master piston which preferably encompasses this master piston in the radial direction and which preferably has at least one sealing lip or sealing edge which in the mounted state bears sealingly against the master cylinder. The seal is injection molded onto the master piston, i.e., configured by an injection molding method. In other words, the master piston is overmolded with the seal by the injection molding method, such that this seal is attached in an immovable manner and fixedly in position on the master piston.

The advantage of the master piston which has a seal which is formed by an injection molding method is that a tolerance chain is shorter between the seal and the piston bore in which the master piston can be arranged so as to be movable in a reciprocal manner. In a conventional master piston, a seal is mounted on a machined surface of the piston element so that the tolerance chain of the conventional master piston contains the surface of the conventional piston element on which the seal is mounted and the seal itself. Thus, relative to a conventional master piston the tolerance chain is improved by the master piston according to the invention in which the seal is mounted by the injection molding process. Additionally, the arrangement of the seal is very accurate via the injection molding method, so that a very accurate positioning of the seal is ensured. The sealing performance of the seal is improved by the accurate positioning and the improved tolerance chain, whereby a particularly accurate or precise manufacturing tolerance is achieved overall. This improves a braking action and a braking precision of a hydraulic vehicle brake which contains the master piston according to the invention. Due to the high manufacturing tolerance, it can be additionally ensured that the seal bears sealingly against the mating surface, i.e., against the piston bore in the master cylinder, in all operating situations. Additionally, due to the high manufacturing tolerance, frictional forces can be reduced in the entire system, i.e., in the hydraulic vehicle brake, which comprises the master piston according to the invention.

In a conventional master piston, as already described above, the seal is mounted on a surface of the piston element. In other words, this surface has to be machined so that the seal can be positioned as accurately as possible. This operating step is dispensed with in the master piston according to the invention so that working time can be saved and the production costs of the master piston can be reduced overall. In conventional master pistons, grooves also have to be provided by machining, for example, in order to position the seal. This is not necessary in the master piston according to the invention, whereby the production costs can be additionally reduced. Moreover, in the master piston according to the invention the mounting of the seal is also dispensed with, since the seal is directly attached to the piston element by the injection molding method. As a result, further costs can be saved.

According to a preferred development of the invention, the master piston is formed as a two-component injection molded part, wherein one component is the piston element and the other component is the seal. In other words, the piston element is preferably produced in a first injection molding process and the at least one seal on the piston element is produced in a further injection molding process. Examples of corresponding two-component injection molding methods or multi-component injection molding methods are transfer technology injection molding methods, rotary/displacement technology injection molding methods and core-back technology injection molding methods. The two-component injection molding method can be selected according to the application, so that the master piston can be produced as cost-effectively as possible and with sufficient quality. The production of the master piston with the piston element and the at least one seal by a corresponding two-component injection molding method is advantageous, since the two-component injection molding method can be automated in a particularly simple manner. Additionally, the production time is significantly shorter than in a conventional master piston in which the piston element is configured as a turned part, for example, and the seal is mounted on the piston element by the seal being pulled on. Moreover, in a two-component injection molded part, a parting plane of the piston element can run in the axial direction. In a conventional master piston in which the piston element is produced by an injection molding method and the seal is mounted on a surface of the piston element, this is associated with a greater risk of leakage. The injection molding method with an axial parting plane produces a burr on the surface on which the seal is intended to be mounted, so that the seal cannot be positioned sealingly on the surface. In other words, a leakage path would be produced in the parting plane in a conventional master piston, the piston element thereof having an axial parting plane, since a burr is formed there by the injection molding method and thus the seal does not bear fully against the piston element. An axial parting plane of the piston element is advantageous in the injection molding method since the piston element can be demolded thereby more simply.

Additionally, the master piston has at least one guide portion which is configured for guiding the master piston in the mounted state in the piston bore of the master cylinder. In other words, the master piston can be radially guided via the guide portion. This is advantageous since the master piston then does not tilt in the piston bore. Thus the hydraulic vehicle brake which contains the master piston according to the invention can be reliably actuated.

The guide portion is configured at least partially, preferably substantially entirely, from a different material from the piston element and is formed by an injection molding method on the piston element. In particular, the guide portion can be formed from a material which has particularly good sliding properties and can be processed in a simple manner by the injection molding method. For example, the guide portion can be formed from fluoropolymer, for example from PVDF (polyvinylidene fluoride), ETFE (ethylene tetrafluoroethylene copolymer) or PFA (perfluoroalkoxy polymer) or from polyolefin, for example from PE (polyethylene) or PP (polypropylene). In particular, the guide portion is formed from PVDF or PP. Due to the injection molded guide portion, the frictional forces can be further reduced in the vehicle brake with the master piston according to the invention.

In particular, it is possible that the master piston, which contains the piston element, the at least one seal and the guide portion, is produced by a multi-component injection molding method. The piston element can be formed in a first injection molding process, while the seal and the guide portion are produced in a further injection molding process or at least two further injection molding processes. In other words, the seal can be produced in a second injection molding process and the guide portion can be produced in a third injection molding process, or the guide portion can be produced in a second injection molding process and the seal can be produced in a third injection molding process. It is also possible that the seal and the guide portion are produced in a common injection molding process.

The guide portion is preferably configured such that it can preferably be deformed in a rubber-elastic or visco-elastic manner in the radial direction, so that the master piston can be prevented from jamming. The guide portion can also be configured from a suitable material and/or a shape of the guide portion is configured such that a deformation of the guide portion in the radial direction is possible. In particular, since the guide portion can be deformed or distorted, the service life of the hydraulic vehicle brake is increased which has the master piston according to the invention, since for example in a conventional master piston which is configured, for example, from POM (polyoxymethylene), over time the master piston jams due to the swelling processes of the materials of the master piston in the fluid. This is prevented by the radially deformable guide portion. The guide portion can be deformable in a radial direction in a rubber-elastic or visco-elastic manner.

The guide portion of the master piston according to the invention is preferably configured such that it has elements which are spaced apart, in particular, uniformly in the circumferential direction and which are configured for guiding the master piston while fluid, for example brake fluid or hydraulic oil, can flow between the elements. In other words, the guide portion can have radial recesses which are spaced apart, in particular, uniformly from one another and which preferably are configured continuously from one axial side of the guide portion to the other axial side of the guide portion. As a result, fluid can flow through the recesses from one axial side of the guide portion to the other axial side of the guide portion. This is advantageous since the seal which is arranged on one axial side of the guide portion can be wetted/lubricated by the fluid which flows through the guide portion, whereby it is possible to increase the service life of the hydraulic vehicle brake which has the master piston. The guide portion is also lubricated by the fluid flowing through. In other words, insufficient lubrication of the guide portion and/or the seal can be prevented by the guide portion with the elements.

In particular, the elements of the guide portion are formed in a rib-shaped manner and protrude radially outwardly away from the piston element. The fluid can flow in the axial direction between the rib-shaped elements which are spaced apart in the circumferential direction, in particular, with a uniform spacing.

In a further exemplary embodiment of the invention, the elements can also be configured to be honeycomb-shaped, for example, wherein the honeycomb-shaped elements extend in the radial direction away from the piston element. The elements can be spaced apart from one another over the circumference and/or in the axial direction. It is possible, for example, that at least two rows of honeycomb-shaped elements are arranged adjacent to one another in the axial direction, wherein one respective row extends over the circumference around the piston element. In particular, the honeycomb-shaped elements can partially overlap in the axial direction.

According to the invention, it is also possible that the recesses are configured between the elements in a Y-shaped manner, wherein the recesses extend in the axial direction. In other words, a portion of one respective recess, in particular, parallel to the axial direction, can extend from the one axial side of the guide portion, which preferably faces away from the seal, in the direction of the other axial side of the guide portion. In each case two further portions of one respective recess, which are spaced apart from one another over the circumference, can from the other axial side in the direction of the portion which extends from the axial side of the guide portion which preferably faces away from the seal, so that the three portions form the respective Y-shaped recess.

In particular, the guide portion is arranged on a low-pressure side of the seal and the seal preferably bears against the guide portion with a lateral circumferential side which extends in the radial direction. This is advantageous since if the seal slides in a braking procedure over an opening which connects the piston bore to an expansion tank, the seal is supported by the guide portion. Thus it is ensured that the seal does not turn inside out.

In one exemplary embodiment, the guide portion can be configured such that it at least partially encompasses the seal in the radial direction. In other words, the guide portion is preferably provided on an axial side of the seal, in particular, on a low-pressure side of the seal, and partially encompasses the seal radially in the axial direction. The seal can have different regions, for example, wherein one region has a smaller external circumference than the other region. The region with the smaller external circumference can be encompassed radially externally by the guide portion. It is also possible that the external circumference of the seal becomes larger, in particular, in a linear manner, from an axial side which faces the guide portion to the other axial side, and the guide portion accordingly has an increasing internal circumference, wherein the external circumference of the seal and the internal circumference of the guide portion partially bear against one another.

In a further exemplary embodiment, the guide portion can have two segments, wherein one respective segment is arranged on one respective axial side of the seal. In other words, the guide portion can be divided, wherein one respective part can be arranged on one respective axial side of the seal. This is advantageous since the seal is thus supported on both sides and the guidance is improved.

According to the invention, the guide portion can have a scraper lip and/or a lip element which extends radially outwardly away from the guide portion. If the scraper lip is arranged on the low-pressure side or the guide portion is arranged such that it is not arranged on the fluid side of the seal, the scraper lip preferably protects from the ingress of dirt and water. The lip element can also be configured as an additional fluid seal.

Additionally, a spring can be integrated in the seal, the sealing edge or sealing lip being subjected thereby to a spring force radially outwardly. The spring can be formed, for example, from a plurality of spring elements which protrude radially outwardly from the piston element. In particular, the spring elements are spaced apart from one another uniformly in the circumferential direction. The spring is configured, for example, such that it forms a funnel shape or a cone shape. In other words, one respective spring element preferably extends from a low-pressure side to a high-pressure side and outwardly in a radial direction. In other words, one respective spring element is preferably arranged at an angle, for example an angle of 45°, relative to the longitudinal axis L of the master piston.

The spring according to the invention can be, in particular, an integral constituent part of the piston element, i.e., it can be produced in one piece with the piston element.

Alternatively, it is also possible that the spring is designed as a separate element from the piston element. This separate element can be mounted, for example, on the piston element before the piston element is over-molded with the seal.

The integration of the spring in the seal is advantageous since a particularly uniform force control/contact pressure of the sealing edge or sealing lip of the seal against the internal surface of the master cylinder is thus made possible. As a result, the balance of forces is also improved in the circumferential direction of the seal when pressure is applied thereon, whereby the friction is reduced when the master piston according to the invention is moved in the master cylinder. This results in reduced wear.

Moreover, it is possible for wear to be compensated by the spring, since the spring force acts on the sealing edge or sealing lip. Moreover, the sealing lip or sealing edge is stiffened by the spring element and the sealing lip/sealing edge is protected against undesirably turning inside out or folding over. Additionally a more accurate definition of a sealing edge position or sealing lip position can be implemented by the spring, whereby a pressure point is improved, for example, when actuating the hydraulic vehicle brake which has the master piston according to the invention.

In a preferred exemplary embodiment, the master piston also has at least one further seal. This further seal is arranged, in particular, such that when actuating the hydraulic vehicle brake which has the master piston, the opening which connects the piston bore to the expansion tank is arranged between the seals. The further seal can be configured according to one or more of the above-described aspects.

Additionally, in a further preferred exemplary embodiment the master piston can have a second guide portion. The further guide portion can be configured according to one of more of the above-described aspects. The second guide portion can have, in particular, at least one scraper lip which extends radially outwardly therefrom and in the mounted state bears against the piston bore to prevent the ingress of dirt and water.

In a preferred embodiment of the invention, the master piston has two seals and two guide portions.

The master piston or the piston element can be formed at least partially from a metal, in particular, from aluminum. Preferably, the master piston/the piston element is formed at least partially, preferably substantially entirely, from a plastics material, in particular, from PA (polyamide) and/or PPA (polyphthalamide) and/or PPS (polyphenylene sulfide). PPA is preferred. It is possible that when the master piston is produced from a plastics material and is produced by an injection molding method, it has at least one insert part, for example made of metal. The insert part can be the spring, for example. Other insert parts are also possible, for example, in order to increase the stiffness of the master piston.

The seal can be formed at least partially, preferably substantially entirely, from elastomer, in particular, HNBR (hydrogenated nitrile butadiene rubber) and/or NBR (nitrile rubber) and/or FKM (fluorine rubber). It is also possible that the seal is produced at least partially, preferably substantially entirely, from at least one thermoplastic elastomer, such as for example thermoplastic polyurethane elastomer (TPU). In terms of process technology, a multi-component injection molding can be used with this family of materials. The aforementioned materials are particularly advantageous if the fluid is hydraulic oil. If the fluid is a brake fluid, for example DOT 3.0 or DOT 4.0 or DOT 5.1, the seal can be formed at least partially, in particular, substantially entirely, from EPDM (ethylene propylene diene monomer rubber). Other materials are also possible. It is advantageous if the material of the seal has a resistance against hydraulic oil and/or brake fluid and/or is suitable for processing by an injection molding method.

The hydraulic vehicle brake according to the invention has a master piston as explained above.

The hydraulic vehicle brake can be configured such that it has at least one master cylinder. The master cylinder can have a piston bore in which the master piston is arranged so as to be movable in a reciprocal manner along its longitudinal axis L. The master cylinder can also have an expansion tank which can be connected via at least one opening to the piston bore for the exchange of fluid. In a state in which no braking is taking place, the master piston is preferably arranged in the piston bore such that a defined pressure chamber is connected via the opening to the expansion tank. During a braking procedure, the master piston can be displaced, in particular, in the piston bore such that the seal slides over the opening, so that the pressure chamber in which brake pressure prevails is not connected via the opening to the expansion tank. If the brake pressure is released, the seal in turn preferably slides over the opening so that the pressure chamber is connected to the expansion tank.

The hydraulic vehicle brake can be, in particular, a vehicle brake for a vehicle with handlebars, namely a bicycle, an E-bike, a pedelec, an electric scooter, or motorcycle, wherein an actuating device for the vehicle brake can be arranged on the handlebars. In particular, the vehicle brake is a hydraulic bicycle brake or a motorcycle brake.

In a method according to the invention for producing the master piston, the seal is injection molded onto the piston element, i.e., is attached to the piston element in the course of an injection molding method.

Additionally, at least one guide portion which is formed from a different material from the piston element can be attached onto the piston element by an injection molding method.

### BRIEF DESCRIPTION OF THE DRAWINGS

The invention is explained in more detail hereinafter with reference to exemplary embodiments shown in the drawing. In the drawing:

FIG. 1 shows a master piston in a sectional view (FIG. 1a) and in a partial sectional view (FIG. 1b);

FIG. 2 shows a further master piston in a perspective sectional view;

FIG. 3 shows a master piston in a partial sectional view (FIG. 3a) and in a partial perspective sectional view (FIG. 3b);

FIG. 4 shows a master piston in a partial sectional view;

FIG. 5 shows a master piston in a perspective detailed view;

FIG. 6 shows a master piston in a perspective detailed view;

FIG. 7 shows the master piston according to FIG. 1a in a detailed view;

FIG. 8 shows a master piston in a partial sectional view; and

FIG. 9 shows a block diagram of the method according to the invention for producing the master piston.

### DETAILED DESCRIPTION OF EMBODIMENTS OF THE INVENTION

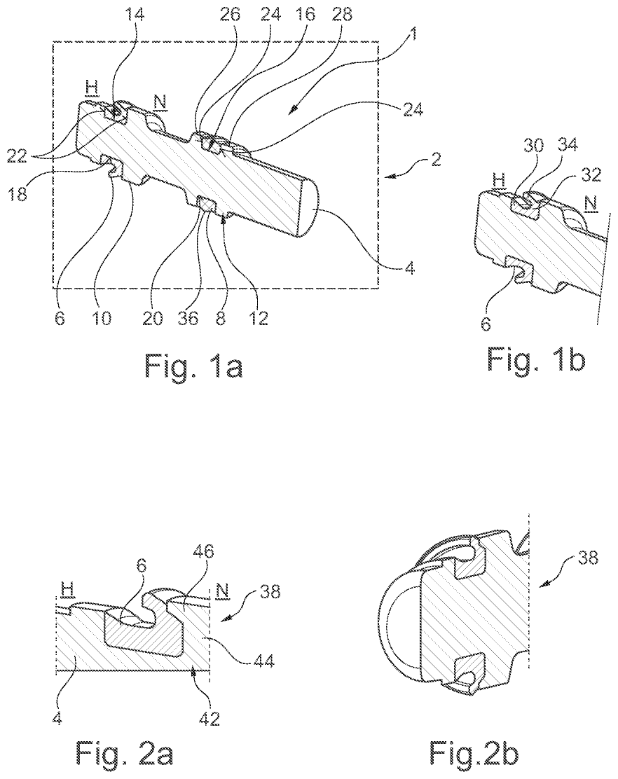

FIG. 1a shows a master piston 1 for a hydraulic vehicle brake 2. The vehicle brake 2 is indicated in FIG. 1a by a dashed line. The master piston 1 comprises a piston element 4 and two seals 6, 8. The seals 6, 8 are arranged spaced apart from one another in an axial direction relative to the longitudinal axis of the master piston 1. The seal 6 is a primary seal and the seal 8 is a secondary seal. Moreover, the master piston 1 has two guide portions 10, 12 for guiding the master piston 1 in a master cylinder of the vehicle brake 2.

The piston element 4 is configured rotationally symmetrically and has two circumferential grooves 14, 16 for the seals 6, 8. The grooves 14, 16 are arranged spaced apart from one another. The grooves 14, 16 in this case are cut off at right-angles, wherein other groove shapes are also possible, however. The grooves 14, 16 can differ from one another or can be the same in terms of size and shape. The seals 6, 8 are injection molded onto the piston element. The seals 6, 8 in each case bear on three sides against the respective groove 14, 16. In other words, the seals 6, 8 in each case bear with their respective internal circumferential sides 18, 20 and in each case with their respective lateral circumferential sides 22, 24 against the respective grooves 14, 16.

The guide portion 10 is arranged on a low-pressure side N of the seal 6 and supports the seal in the direction of the low-pressure side N. In other words, the seal 6 bears against the guide portion 10 on a lateral circumferential side 22 on the low-pressure side N.

The guide portion 12 has two segments 26, 28 which are arranged on one respective axial side of the seal 8. The segments 26, 28 support the seal 8 in each case on the lateral circumferential sides 24 in the axial direction.

In FIG. 1b it is shown that the seal 6 has a foot portion 30 on the internal circumferential side. The foot portion 30 extends in the axial direction and encompasses the piston element 4 in a radial direction. Moreover, the seal 6 has a connecting portion 32 which extends from the foot portion 30 on an axial side of the foot portion 30, in this exemplary embodiment on the low-pressure side N, outwardly in the radial direction and a seal edge portion 34 which extends away from the foot portion 30 axially in the direction of a high-pressure side H and radially outwardly, so that a sealing edge of the seal 6 sealingly bears against a master cylinder which is not shown in FIG. 1b.

The seal 8, see FIG. 1a, is configured symmetrically in the axial direction and has in its axial center a bulge 36 which extends outwardly in the radial direction, so that an apical sealing edge of the seal 8 bears sealingly against the master cylinder.

FIG. 2a shows a master piston 1, the guide portion 42 thereof differing from the guide portion 10 of FIG. 1. The guide portion 42 in this case encompasses the seal 6 in some portions in a radial direction and also in an axial direction. In other words, the guide portion 42 has a bottom portion 44 which protrudes radially outwardly, and an encompassing portion 46 which protrudes in the axial direction in the direction of the high-pressure side H and encompasses the seal in some portions in the radial direction. In other words, the guide portion 42 forms an approximately C-shaped recess which is open in the axial direction and in the direction of the high-pressure side H and in which the seal 6 is inserted. FIG. 2b shows the master piston 1 from a different perspective.

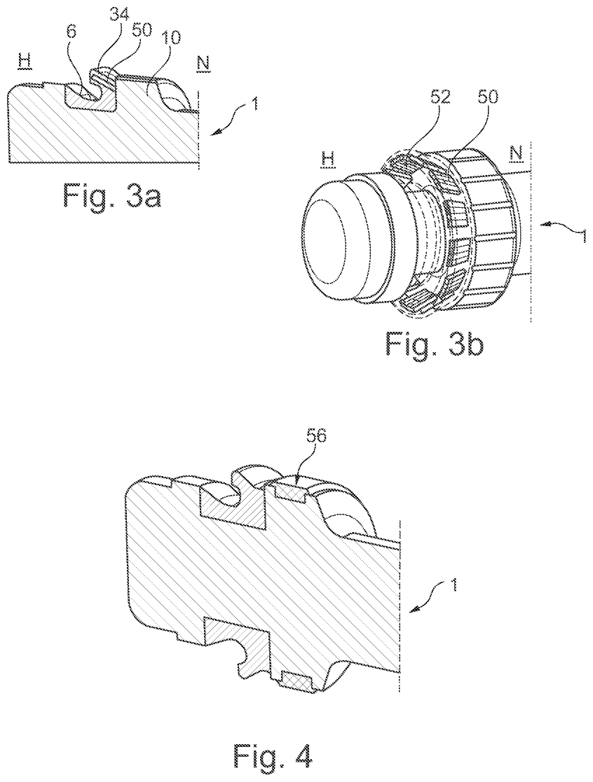

FIG. 3a shows a further master piston 1, which differs substantially from the master piston 1 of FIG. 1 in that a spring 50 is integrated in the seal 6 or in the material thereof. The spring 50 protrudes from the guide portion 10 in the direction of the high-pressure side H and radially outwardly. The spring 50 can be produced in one piece with the piston element 4, for example, by an injection molding method. However, it is also possible that the spring 50 is over-molded with the seal. The sealing edge portion 34 of the seal 6 is subjected to a spring force by the spring 50, so that the sealing edge is pushed radially outwardly in order to bear sealingly against the master cylinder.

According to FIG. 3b the spring 50 can be configured from a plurality of spring elements 52 which are arranged spaced apart from one another in the circumferential direction.

FIG. 4 shows a master piston 1 with a guide portion 56 which is formed from a different material from the piston element 4. In other words, the master piston 1 is configured by a multi-component injection molding method, wherein the guide portion 56 forms one component.

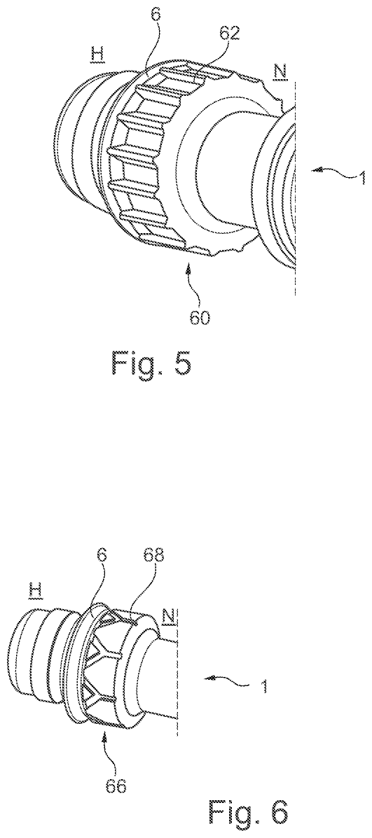

A master piston 1 which has a guide portion 60 with rib-shaped projections 62 which extend in the axial direction of the master piston 1 is shown in FIG. 5. The projections 62 protrude outwardly in a radial direction and are arranged spaced apart uniformly from one another in the circumferential direction. The projections 62 serve for guiding the master piston 1. As fluid can flow between the projections 62, it is ensured that the guide portion 60 is sufficiently lubricated during the operation of the master piston 1. The seal 6 can be lubricated thereby on both sides in the axial direction.

A master piston 1 which has a guide portion 66 with Y-shaped recesses 68 which are arranged spaced apart uniformly from one another in the circumferential direction is shown in FIG. 6. A first portion of one respective recess 68 can extend parallel to the axial direction from the low-pressure side N to the high-pressure side H. In each case two portions of one respective recess 68, which are spaced apart from one another over the circumference and which approach one another from the high-pressure side H to the low-pressure side N, extend from the high-pressure side so that the three portions form the respective Y-shaped recess 68.

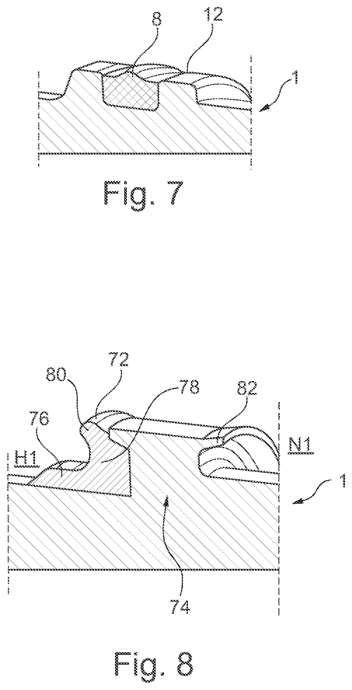

In FIG. 7 the master piston 1 according to FIG. 1 is shown enlarged in some portions, wherein the seal 8 and the guide portion 12 are shown in detail.

FIG. 8 shows a master piston 1 with a secondary seal 72 and a second guide portion 74. The seal 72 has a foot portion 76 which extends in the axial direction and which contains an internal circumferential surface of the seal 72. A connecting portion 78 extends in the radial direction away from this foot portion on a low-pressure side N1 of the seal 72. A sealing edge portion 80 extends away from the connecting portion 78 in the axial direction in the direction of the high-pressure side H1 of the seal 72, and in the radial direction, wherein the sealing edge portion 80 has a sealing edge which sealingly bears against the master cylinder, which is not shown.

The guide portion 74 encompasses the seal 72 in the axial direction so that the connecting portion 78 in the radial direction is encompassed partially by the guide portion 74, viewed from radially outwardly. On the low-pressure side N1 the guide portion 74 has a scraper lip 82. This scraper lip can be injection molded or configured in one piece with the guide portion 74. This can prevent the ingress of dirt.

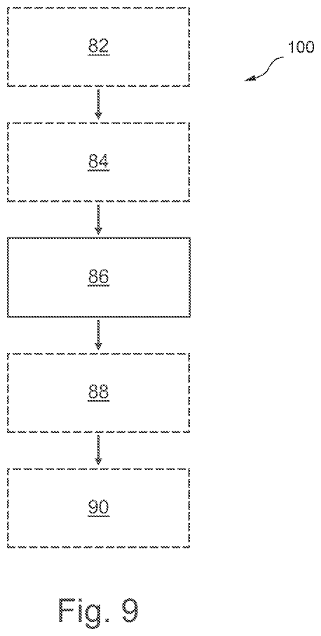

FIG. 9 shows a block diagram of a method 100 for producing a master piston 1, for example according to FIG. 1. In an optional first step 82, an insert part, for example the spring 50 of FIG. 3a, is inserted into a cavity for injection molding, i.e., into an injection mold. Subsequently, in a further optional step 84, a piston element 4 is produced by injection molding. If the piston element is to have one or more guide portions, they can be generated in step 84. It is also possible that the piston element 4 is configured as a turned part from aluminum or another metal or plastics material and accordingly inserted into the injection mold. Subsequently in step 86, a seal 6, 8, 72 is injection molded onto the piston element 4 (arranged in the injection mold). Additionally, in a further optional step 88, one or more further seals 6, 8, 72 can be injection molded onto the piston element 4. Additionally, in a further optional step 90, a guide portion 10, 12, 42, 56, 60, 66, 74 can be produced, in particular, on the remaining piston element 4. The steps 86, 88, 90 can be carried out in any sequence or at the same time.

What is claimed is:

1. A master piston for a hydraulic vehicle brake configured to be arranged in a master cylinder of the hydraulic vehicle brake to be movable in a reciprocal manner along a master piston longitudinal axis, the master piston comprising:
a piston element with at least one seal;
wherein the seal is injection molded onto the piston element;
wherein the master piston has at least one guide portion configured for guiding the master piston in the master cylinder;
wherein the at least one guide portion is elastically deformable at least in some portions in a radial direction to the master piston longitudinal axis;
wherein the at least one guide portion is formed at least partially from a different material from the piston element; and
wherein the piston element, the at least one seal and the at least one guide portion are produced together by a multi-component injection molding method.

2. The master piston as claimed in claim 1, wherein the piston element has at least one circumferential groove which is open radially outwards and the seal bears on three sides against the groove.

3. The master piston as claimed in claim 1, wherein the guide portion has at least one recess which extends in an axial direction from one side of the guide portion to the other side of the guide portion, wherein fluid is configured to be conducted through the recess from an axial side of the guide portion to the other side of the guide portion.

4. The master piston as claimed in claim 1, wherein the guide portion has projections which extend away outwardly in a radial direction and which are spaced apart from one another in the circumferential direction of the master piston, wherein the projections are configured to be elastically deformed in the radial direction of the master piston.

5. The master piston as claimed in claim 1, wherein the guide portion is configured where it radially encompasses the seal in some portions in the axial direction.

6. The master piston as claimed in claim 1, wherein at least one spring is integrated in the seal, wherein this spring is configured where a sealing lip or sealing edge of the seal is subjected to a spring force radially outwardly in the radial direction.

7. The master piston as claimed in claim 1, wherein the at least one further seal is injection molded onto the piston element.

8. The master piston as claimed in claim 1, wherein the master piston has at least one further guide portion which is arranged spaced apart from the first guide portion in the axial direction.

9. The master piston as claimed in claim 1, wherein the respective guide portion or at least one of the guide portions has two segments, wherein one respective segment is arranged on one respective axial side of a seal or the seal.

10. The master piston as claimed in claim 1, wherein at least the first and/or each further guide portion has at least one scraper edge and/or scraper lip which extends radially away from the respective guide portion.

11. A hydraulic vehicle brake having the master piston as claimed in claim 1.

12. The hydraulic vehicle brake as claimed in claim 11, wherein the hydraulic vehicle brake is configured for a vehicle with handlebars.

13. The hydraulic vehicle brake as claimed in claim 12, wherein the vehicle with handlebars is a bicycle.

14. A method for producing the master piston as claimed in claim 1 in the multi-component injection molding method, comprising the following method steps, which can be carried out in any sequence or at the same time:
injection molding of the piston element;
injection molding of the at least one guide portion onto the piston element; and
injection molding of the at least one seal onto the piston element.

15. The method as claimed in claim 14, wherein prior to injection molding of the at least one seal, an insert part is inserted into a cavity of an injection mold of the at least one seal.

16. The method as claimed in claim 15, wherein the insert part is a spring.
